(19) United States
(12) Patent Application Publication
(10) Pub. No.: US 2021/0032824 A1
(43) Pub. Date: Feb. 4, 2021

(54) Elite Doggie Clean Up

(71) Applicant: Scott Swiryn, Citrus Heights, CA (US)

(72) Inventor: Scott Swiryn, Citrus Heights, CA (US)

(21) Appl. No.: 16/947,940

(22) Filed: Aug. 25, 2020

Related U.S. Application Data
(63) Continuation of application No. 16/428,881, filed on May 31, 2019, now Pat. No. 10,787,778.

(51) Int. Cl. E01H 1/12; B65F 1/00

(52) U.S. Cl. CPC E01H 1/1206; B65F 2240/136; B65F 1/0006

(57) ABSTRACT

The Elite Doggie Clean-Up is a one of a kind, portable easy clean up unit. Used for while walking your dog and when picking up your dog's poop. It is very good for owners with back, hip and knee issues including owners with handicap needs. The Elite Doggie Clean up allows all dog owners never have to bend over to pick up or touch the poop during the entire pick up and throw away process.

### FIELD OF THE INVENTION

The Elite Doggie Clean Up is a one of a kind, portable easy clean up unit. Used while walking your dog and for picking up your dog's poop. The Elite Doggie Clean Up system makes it much easier so that the dog owner does not have to ever bend down and pick up or feel the poop by hand.

### DESCRIPTION OF THE RELATED ART

Cleaning up poop is an inevitable part of dog ownership. Poop scoopers have a (swivel or) fixed bin and a pole connector for height adjustment. Poop scoopers have a spring controlled jaw or, tray and a rake combination. The jaws are made of metal or plastic. Most scoopers do not have a self locking mechanism and some motion of hands is involved in picking up of the poop. Poop tends to stick to the serrated teeth on the jaws and tend to scratch surfaces/grass pickups. Some of the more expensive scoopers have extensive and involved clean-up process. For many operators who have small hands and including the elderly, poppers with spring mechanisms are too hard to squeeze, hold and operate. The rake and tray combination units are cumbersome and not convenient to being carried along with a walking dog. Dog owners usually complain when they have to pick up the poop by hand as they have to feel it.

### BRIEF DESCRIPTION OF THE DRAWINGS

FIG. 1 shows the Elite Doggie Clean up system with swivel mechanism and handle.

FIG. 2 shows the claws with the plates and is the preferred embodiment.

FIG. 3 shows the cable clamp mechanism that helps to lock claws in place when triggered.

FIG. 4 shows the push-pull mechanism.

FIGS. 5A and 5B show the handle with the easy grip, flashlight, trigger and various other parts.

FIG. 6 shows the claws, cams in another embodiment.

FIG. 7 shows the cams

FIG. 8 shows the dog leash break mechanism.

FIG. 9 shows the bag used with the claws.

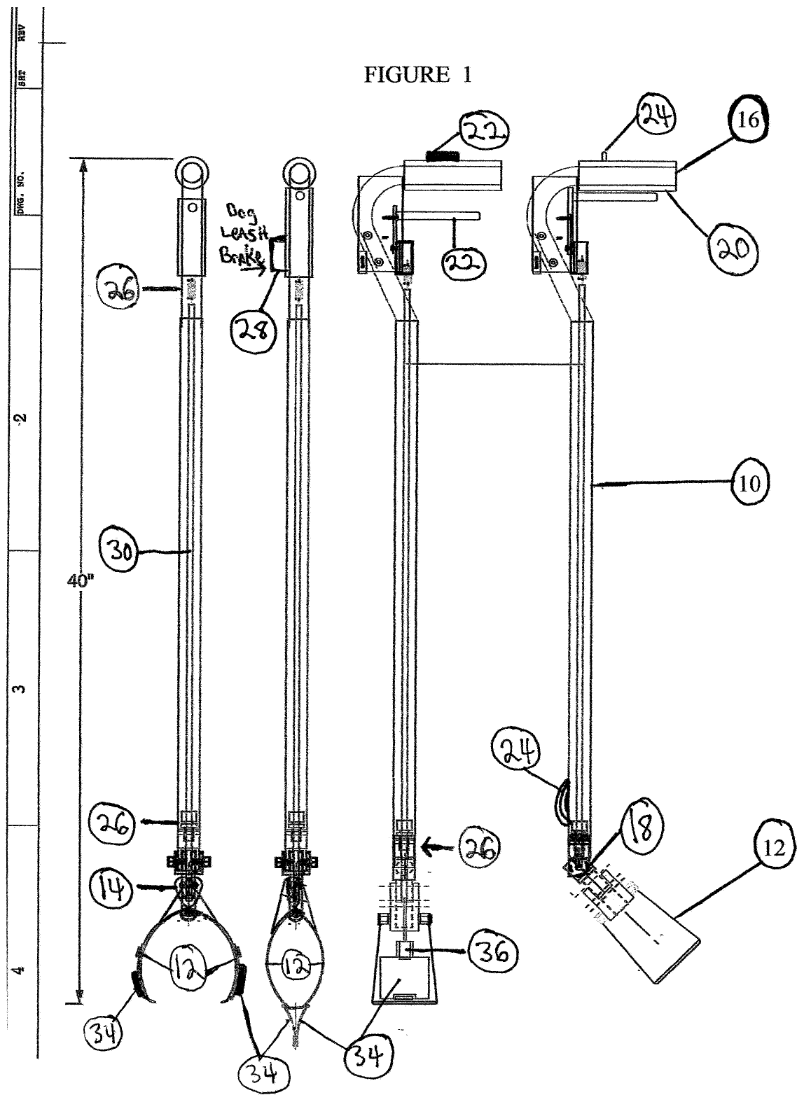

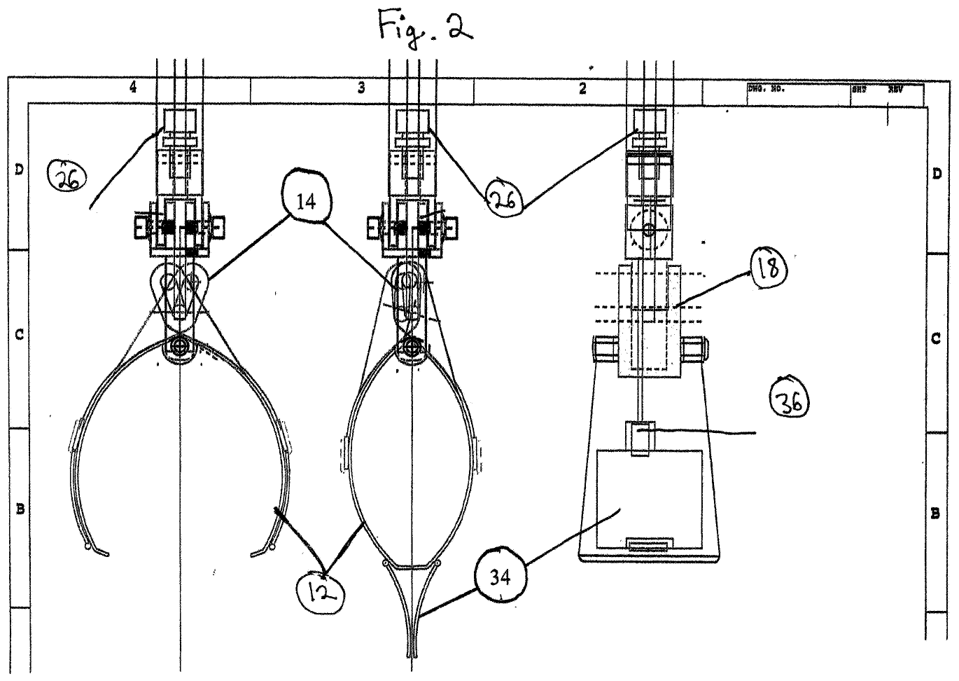

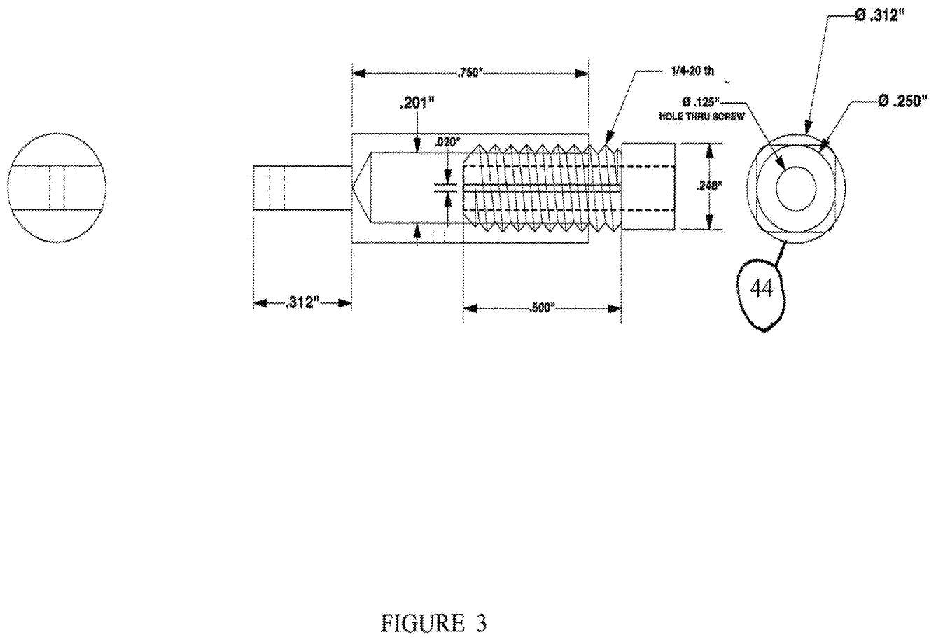

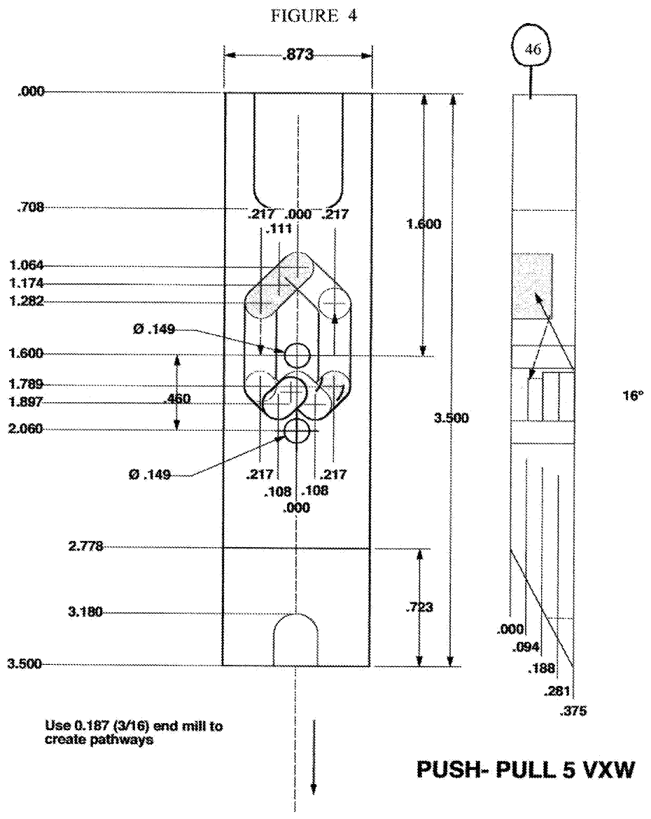

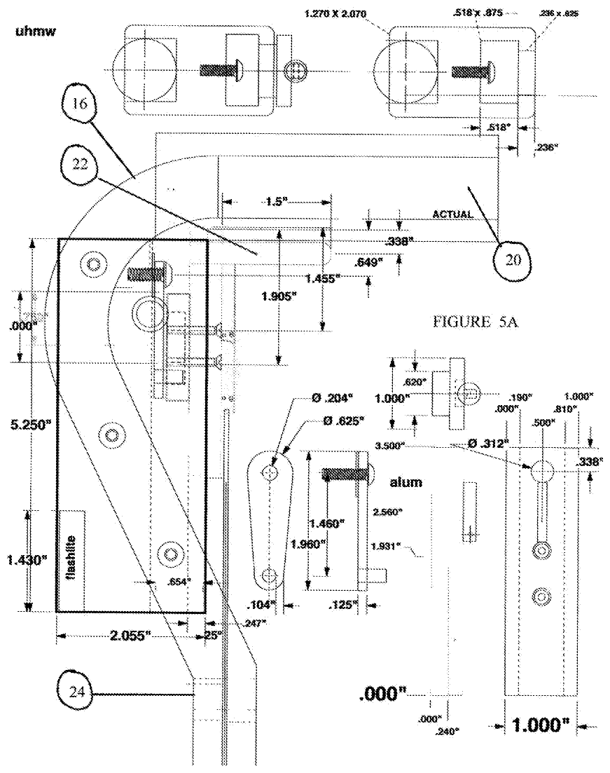

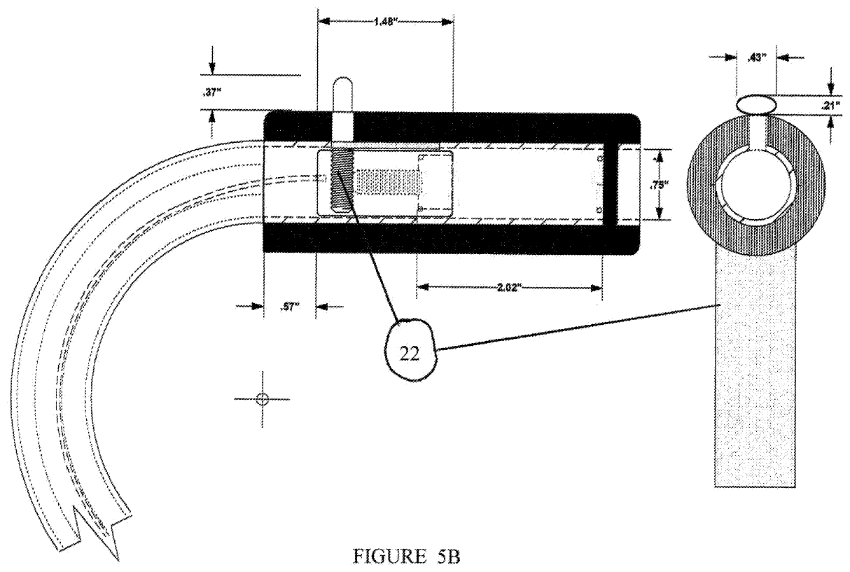

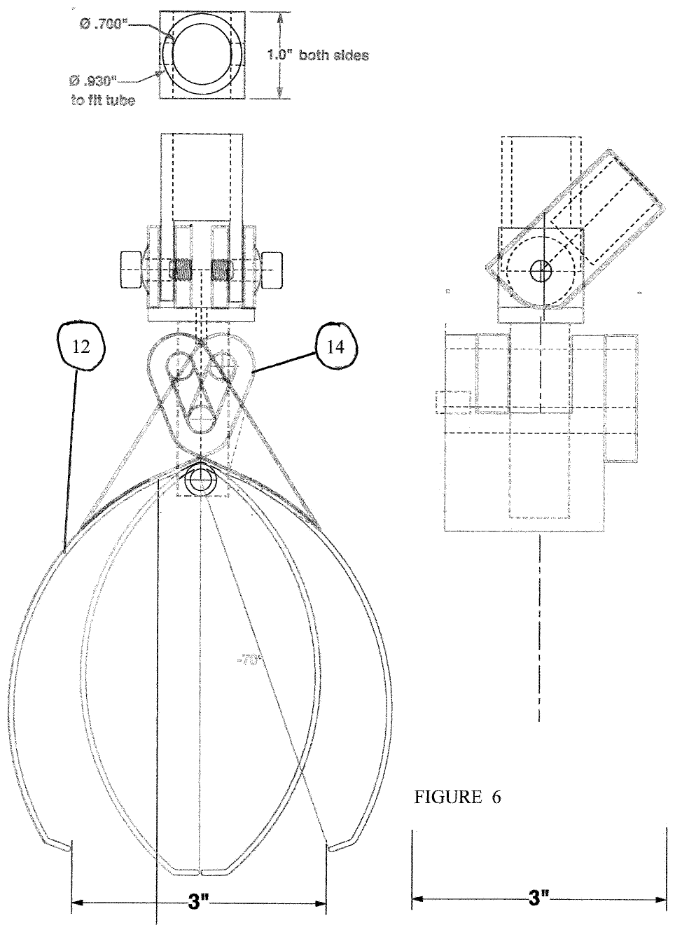

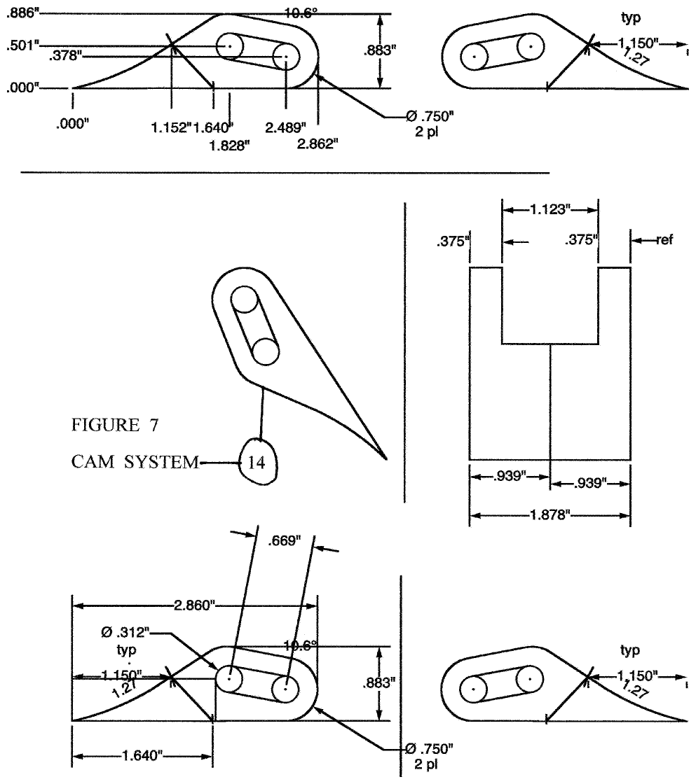

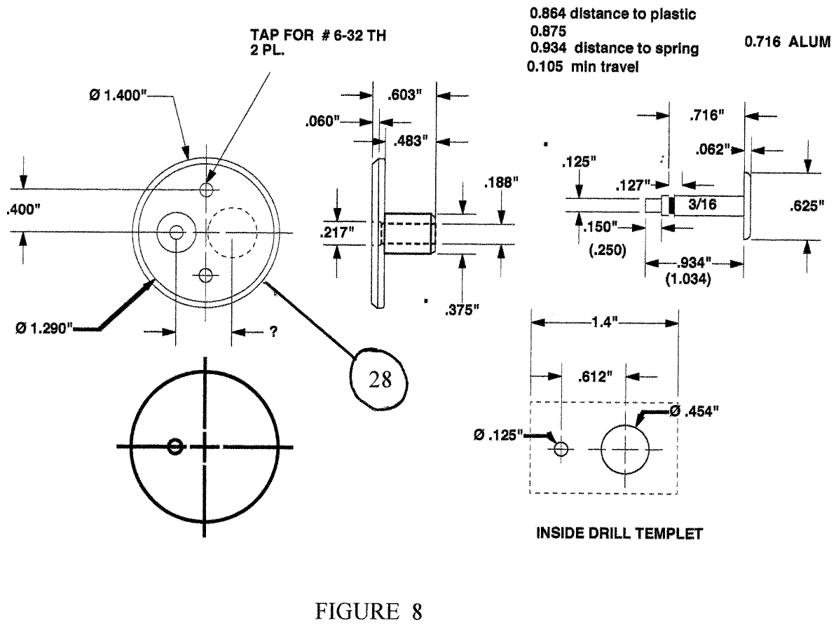

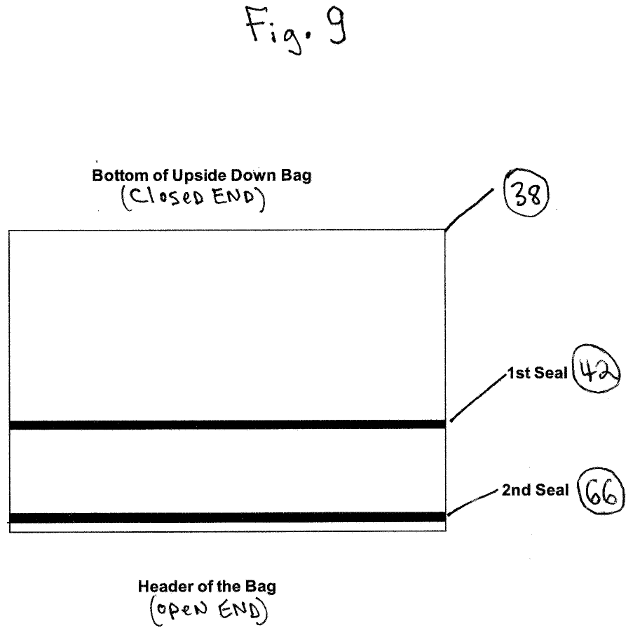

### SPECIFICATIONS

The invention consists of an adjustable height light weight durable pole which bends at continuous angles, not limited to 90 degrees. This feature enables the use of the device for wheel chair users too and for people to adjust it to their heights so it can be also be used for support during walking.

The main tube (10) is a light weight hollow tube. It has cables within it to operate the claws (12) which has two positions open and closed. The claws are attached to a specially designed cams (14) that allows the tube to be pivoted from a 90 degree to a 45 degree position, but not limited to these angles, adjusting to the operators height whether standing or sitting. One end of the main tube has a handle (16) attached. The other end of the handle has claw cam box (18) attached which can swivel.

The handle (16) consists of an easy grip (20) shaped for comfort. It also consists of one or two triggers (22), flashlight (24), cable clamp (26), and a dog leash box(28). More description needed.

The claws (12) are attached to the main tube (10) by specially designed cam claw box which opens and closes the claws. The claws are connected to the claw cams by rivets or screws and the claw clams movement is controlled by string wires (30) which in turn is connected to the trigger (22), specially designed trigger lock mechanism (32). The claws have a substantial opening range for most size of poop. The claws staying in the open or closed position is controlled by a set of cable clamps (44), a push pull mechanism (46) and cables.

The ends of the claws have a plate (34) attached one on each side of the outer edge. The plate is spring (36) loaded and is held in place on the outer edge of the claw for release with a second trigger. The first trigger can be used if additional functions are designed into the first trigger.

A specially designed plastic bag (38) (not shown, patent pending) with a slit (40) can be rolled over the claws (12) and the plate (36). The plastic bag has two sets of Velcro (42) attached on the inside of the bag placed at specific designed distances from each other. This one-of-a-kind hands free double seal velcro design ensures that the double sealed bag will not drip or leak the poop out of the bag.

The claws are opened with the trigger. The plates are rolled back into locked positions (ready for release) as shown in Figure.

The plastic bag (38) is then loaded when the claws are in the open position (42) into the cavity of the claws (12). The plastic bag is then rolled over the claws and then the plates which are attached to the outside of the claws.

The operator first clicks on the first trigger (22) to open the claws. The claws are held in open position, without the operator having to hold on the trigger. The next step is to fold back the plates in locked/ready position which are attached to the outside of to the claws. The plastic bag is then inserted in the into the cavity of the claws. The amount of insertion is specified by the first set of Velcro position which should be at the vertical edges of the claws. The plastic bag section which is outside the claws is then folded/rolled back over the plates and claws. A one time operation is described now. The first trigger can be pressed one more time to lock the claws. At the time when service is needed the trigger can be pressed one more time to open claws with the plastic bag. The claws are held over the doggie poop, the trigger pressed one more time. This action will scoop the doggie poop in to the cavity of the plastic bag and shut the claws. The shutting of the claws will seal the plastic bag with the first set of Velcro strips. The poop is now in a secure place. The operator walks with the poop to a designated drop point in the park. At this point the Elite Doggie scooper is elevated a few inches above the ground at a suggested angle between TO and 45 degrees, but not limited to these angles only. The second trigger is then pressed, which will then release the spring loaded plates and will carry the plastic bag into a closed sealed position with the second set of Velcro strips. The double seal will ensure that dog poop will not be accidentally released out of the plastic bag. Without having to touch the poop or the plastic bag, the operator can now walk to the next drop off point. When the operator presses the second trigger, this will allow the claws to open, release the full plastic bag, and allow the plastic bag to be dropped out into the bin.

1. A bag for retaining waste, comprising:
a bag, having a closed portion, and an opening slit through which waste can be inserted to be held within a cavity defined by the closed portion,
a first openable and sealable closure, extending across the opening slit, and extending from one side of the cavity to another side of the cavity, at a first location of the bag, sealing the bag across a line extending across the bag at the first location;
a second openable and sealable closure, extending across the opening slit, and extending from one side of the cavity to another side of the cavity, at a second location of the bag, spaced from the first location, and the second closure sealing the bag across a second line extending across the bag at the second location, the second line being parallel to the first line;
where the first and second closures each completely close the cavity of the bag and are spaced at a specific designated distance from one another,
to prevent the waste from leaving the bag using the first and second closures as a double seal.

2. The bag as in claim 1, wherein the openable and sealable closures are hook and loop material.

3. The bag as in claim 1, the bag having an opening and a configuration that is sufficiently large to be rolled over a closed version of openable claws of a scooping device.

4. The bag as in claim 3, wherein the bag is sized to have the first closure located at an edge of a claw of the scooping device.

5. The bag as in claim 4, wherein the claws are opened to scoop the waste into the bag, and closed to seal the first closure.

6. The bag as in claim 5. Wherein the scooper also has a plate spaced from the claws by an amount to close the second closure, subsequent to closing the first closure.

7. The bag as in claim 5, wherein when the bag is placed in a position to coordinate in the use with the claws, the opening or mouth of the bag is big enough to hold the claws.
